(19) United States
(12) Patent Application Publication
(10) Pub. No.: US 2005/0216151 A1
(43) Pub. Date: Sep. 29, 2005

(54) Telematic retrieval of vehicle performance information

(75) Inventors: Thomas A. Gawlik, Rochester Hills, MI (US); Douglas H. Devries, Ann Arbor, MI (US); Nathan D. Ampunan, West Bloomfield, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/806,843

(22) Filed: Mar. 23, 2004

(51) Int. Cl. G01M 17/00

(52) U.S. Cl. 701/33; 701/2

(57) ABSTRACT

A system and method for configurable dynamic telematic retrieval of vehicle system performance information. A method describes receiving engine vehicle performance data from at least one vehicle system, processing the received vehicle performance data, and producing vehicle system performance information based on the processed vehicle performance data.

### FIELD OF THE INVENTION

The invention relates to vehicles, and more particularly to methods and systems for obtaining vehicle system performance information through a wireless communication network.

### BACKGROUND OF THE INVENTION

Presently, many passenger vehicles, buses, trucks, and the like, incorporate complex component vehicle systems. The application of very large scale integration components (VLSI) for processing and control functions permits the use of discrete computer controlled sub-systems within a vehicle to control many vital vehicle functions. Generally, each type of vehicle system control module incorporates application-specific software that executes various system functions and also operating parameters for the vehicle system. Furthermore, many vehicles incorporate a vehicle system communication network that permits bi-directional communication between the component systems of such a vehicle. One example of a computer controlled vehicle system is a power-train control module (PCM). The power-train control module for a vehicle typically controls combustion, engine timing and fuel mixture among other functions. Vehicle emissions are therefore controllable via a power train control module, often through the application of one or more engine emission sensors that monitor several parameters of engine combustion and exhaust. Such engine emission data is valuable. When accurately collected, emission data describes the operating condition of a vehicle engine and can, therefore, indicate needed repairs or the onset of wear among other things. Furthermore, emission data is useful for statistical analysis across large sample groups for manufacturers and monitoring agencies.

Many passenger vehicles now incorporate an integrated communication system. A Vehicle Communication Unit (VCU) used in conjunction with a Wide Area Network (WAN) such as a cellular telephone network or a satellite communication system allows for a variety of fee-based subscription services to be provided in a mobile environment. The VCU is typically a vehicle telematics device including a cellular radio, satellite transceiver and/or global positioning capabilities. Communication through a carrier service may be initiated at the VCU at turn-on or through manual or voice command phone number entry. Typically, a radio communication link is established between the VCU and a Wide Area Network (WAN), using a node of the WAN in the vicinity of the VCU.

In addition to enabling telecommunication services, a VCU may be configured to perform various processing functions and to exchange various types of data with a service provider such as service codes and error codes, for example.

It would be desirable therefore, to provide a method and system for providing vehicle emission performance information through a wireless communication network that leverages the above-described capabilities.

### SUMMARY OF THE INVENTION

The present invention is directed to a method for configurable dynamic telematic retrieval of vehicle system performance information, the method including receiving vehicle performance data at a telematics device from at least one vehicle system, processing the received vehicle performance data at the telematics device, producing vehicle system performance information based on the processed vehicle performance data, and communicating the vehicle system performance information to a service provider.

In accordance with yet another aspect of the invention a computer readable medium includes computer readable code for directing a reception of vehicle performance data at a telematics device from at least one vehicle system, computer readable code for processing the received vehicle performance data at the telematics device, computer readable code for producing vehicle system performance information based on the processed vehicle performance data, and computer readable code for directing a communication of the vehicle system performance information to a service provider.

In accordance with still another aspect of the invention, a system for configurable dynamic telematic retrieval of vehicle system performance information includes means for receiving vehicle performance data at a telematics device from at least one vehicle system, means for processing the received vehicle performance data at the telematics device, means for producing vehicle system performance information based on the processed vehicle performance data, and means for communicating the vehicle system performance information to a service provider.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG.1 is an illustrative operating environment for configurable dynamic telematic retrieval of vehicle system performance information in an embodiment of the present invention.

FIG. 2 is a block diagram of a system for configurable dynamic telematic retrieval of vehicle system performance information in accordance with an embodiment of the present invention.

FIG. 3 is a process flow diagram of a method for configurable dynamic telematic retrieval of vehicle system performance information.

### DETAILED DESCRIPTION OF THE PRESENTLY PREFERRED EMBODIMENT

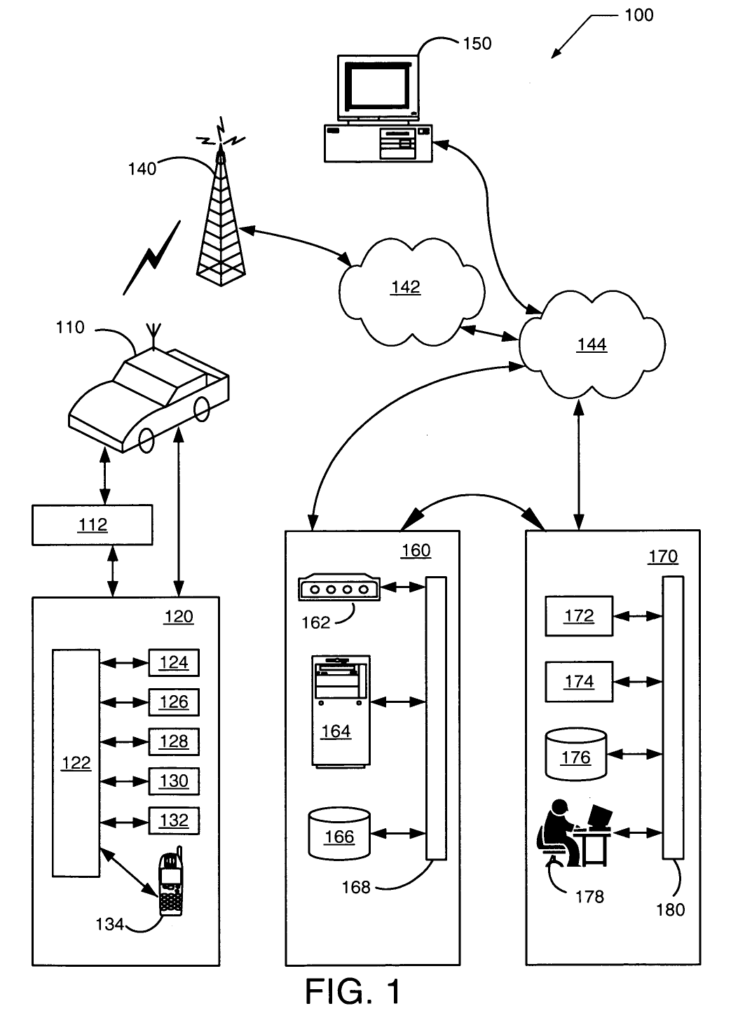

FIG.1 is an illustrative operating environment for configurable dynamic telematic retrieval of vehicle system performance information in an embodiment of the present invention. FIG. 1 shows a mobile vehicle communication system 100. Mobile vehicle communication system 100 includes at least one mobile vehicle 110 (vehicle) including vehicle communication network 112 and vehicle communications unit (VCU) 120, one or more wireless carrier systems 140, one or more communication networks 142, one or more land networks 144, one or more client, personal or user computers 150, one or more web-hosting portals 160, and one or more call centers 170. In one embodiment, mobile vehicle 110 is implemented as a vehicle equipped with suitable hardware and software for transmitting and receiving voice and data communications. VCU 120 is also called a telematics unit or device.

In one embodiment, VCU 120 includes a digital signal processor (DSP) 122 connected to a wireless modem 124, a global positioning system (GPS) unit 126, an in-vehicle memory 128 such as, for example, a non-volatile flash memory, a microphone 130, one or more speakers 132, and an embedded or in-vehicle mobile phone 134. In one embodiment, DSP 122 is a microcontroller, controller, host processor, or vehicle communications processor. In an example, DSP 122 is implemented as an application specific integrated circuit (ASIC). GPS unit 126 provides longitude and latitude coordinates of the vehicle, as well as a time and date stamp. In-vehicle mobile telephone system 134 is a cellular-type phone such as, for example an analog, digital, dual-mode, dual-band, multi-mode, or multi-band cellular phone. In another example, the mobile telephone system is an analog mobile telephone system operating over a prescribed band nominally at 800 MHz. In another example, the mobile telephone system is a digital mobile telephone system operating over a prescribed band nominally at 800 MHz, 900 MHz, 1900 MHz, or any suitable band capable of carrying digital cellular communications.

DSP 122 executes various computer programs and communication control and protocol algorithms that affect communication, programming and operational modes of electronic and mechanical systems within vehicle 110. In one embodiment, DSP 122 is an embedded system controller. In another embodiment, DSP 122 controls communications between telematics device 120, wireless carrier system 140, and call center 170. In yet another embodiment, DSP 122 controls communications between the wireless modem 124 and nodes of a mobile ad hoc network. In still another embodiment, DSP 122 provides processing, analysis, and control functions for determining engine emission performance for vehicle 110. DSP 122 is configured to generate and receive digital signals transmitted between telematics device 120 and a vehicle communication network 112 that is connected to various electronic modules in the vehicle 110. In one embodiment, the digital signals activate a programming mode and operation modes, as well as provide for data transfers. In another embodiment, a utility program facilitates the transfer of emission data, emission analysis data, instructions, triggers and data requests between vehicle 110 and a call center 170.

Mobile vehicle 110, via a vehicle communication network 112, sends signals to various units of equipment and systems within vehicle 110 to perform various functions such as monitoring the operational state of vehicle systems; collecting and storing data from the vehicle systems; providing instructions, data and programs to various vehicle systems; and calling from telematics device 120. In facilitating interactions among the various communication and electronic modules, vehicle communication network 112 utilizes bus interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Vehicle 110, via telematics device 120, sends to and receives radio transmissions from wireless carrier system 140. Wireless carrier system 140 is implemented as any suitable system for transmitting a signal from mobile vehicle 110 to communication network 142. Wireless carrier system 140 incorporates any type of telecommunications in which electromagnetic waves carry signal over part of or the entire communication path. In one embodiment, wireless carrier system 140 transmits analog audio and/or video signals. In an example, wireless carrier system 140 transmits analog audio and/or video signals such as those sent from AM and FM radio stations and transmitters, or digital audio signals in the S band (approved for use in the U.S.) and L band (used in Europe and Canada). In one embodiment, wireless carrier system 140 is a satellite broadcast system broadcasting over a spectrum in the S band (2.3 GHz) that has been allocated by the U.S. Federal Communications Commission (FCC) for nationwide broadcasting of satellite-based Digital Audio Radio Service (DARS).

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144. In one example, wireless carrier system 140 includes a short message service, modeled after established protocols such as IS-637 SMS standards, IS-136 air interface standards for SMS, and GSM 03.40 and 09.02 standards. Similar to paging, an SMS communication could be broadcast to a number of regional recipients. In another example, the carrier system 140 uses services in accordance with other standards such as, for example, IEEE 802.11 compliant wireless systems and Bluetooth compliant wireless systems.

Land network 144 is a public-switched telephone network (PSTN). In one embodiment, land network 144 is implemented as an Internet protocol (IP) network. In other embodiments, land network 144 is implemented as a wired network, an optical network, a fiber network, another wireless network, a virtual private network (VPN) or any combination thereof. Land network 144 is connected to one or more landline telephones. Land network 144 connects communication network 142 to user computer 150, web-hosting portal 160, and call center 170. Communication network 142 and land network 144 connect wireless carrier system 140 to web-hosting portal 160 and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160 and vehicle 110. Personal or user computer 150 sends data to web-hosting portal 160 through a web-page interface using communication standards such as hypertext transport protocol (HTTP) and transport-control protocol Internet protocol (TCP/IP). In one embodiment, the data includes directives to change certain programming and operational modes of electronic and mechanical systems within vehicle 110. In another embodiment, the data includes requests for certain data such as vehicle system performance information. In operation, a user such as, for example, a vehicle designer or manufacturing engineer, utilizes user computer 150 to exchange information with mobile vehicle 110 that is cached or stored in web-hosting portal 160. In an embodiment, vehicle system performance information from client-side software is transmitted to server-side software of web-hosting portal 160. In one embodiment, vehicle system performance information is stored at web-hosting portal 160. In another embodiment, client computer 150 includes a database (not shown) for storing received vehicle system performance data. In yet another embodiment, a private Local Area Network (LAN) is implemented for client computer 150 and web-hosting portal 160, such that the web-hosting portal is operated as a Virtual Private Network (VPN).

Web-hosting portal 160 includes one or more data modems 162, one or more web servers 164, one or more databases 166, and a network 168. Web-hosting portal 160 is connected directly by wire to call center 170, or connected by phone lines to land network 144, which is connected to call center 170. Web-hosting portal 160 is connected to land network 144 by one or more data modems 162. Land network 144 transmits digital data to and from modem 162; data that is subsequently transferred to web server 164. In one implementation, modem 162 resides inside web server 164. Land network 144 transmits data communications between web-hosting portal 160 and call center 170.

Web server 164 receives various data, requests or instructions from user computer 150 via land network 144. In alternative embodiments, user computer 150 includes a wireless modem to send data to web-hosting portal 160 through a wireless communication network 142 and a land network 144. Data is received by modem 162 and sent to one or more web servers 164. In one embodiment, web server 164 is implemented as any suitable hardware and software capable of providing web services to transmit and receive data from user computer 150 to telematics device 120 in vehicle 110. Web server 164 sends to or receives data transmissions from one or more databases 166 via network 168. In an embodiment, web server 164 includes computer applications and files for managing emission performance data.

In one embodiment, one or more web servers 164 are networked via network 168 to distribute vehicle engine emission performance data among its network components such as database 166. In an example, database 166 is a part of or a separate computer from web server 164. In one embodiment, web server 164 sends data transmissions including vehicle system performance information to call center 170 via modem 162 and through land network 144.

Call center 170 is a location where many calls are received and serviced at the same time, or where many calls are sent at the same time. In one embodiment, the call center is a telematics call center, facilitating communications to and from telematics device 120 in vehicle 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more networks 180.

Switch 172 of call center 170 connects to land network 144. Switch 172 transmits voice or data transmissions from call center 170, and receives voice or data transmissions from telematics device 120 in mobile vehicle 110 through wireless carrier system 140 and/or wireless modem 124, communication network 142, and land network 144. Switch 172 receives data transmissions from and sends data transmissions to one or more web-hosting portals 160. Switch 172 receives data transmissions from or sends data transmissions to one or more communication services managers 174 via one or more networks 180.

Communication services manager 174 is any suitable hardware and software capable of providing communication services to telematics device 120 in mobile vehicle 110. Communication services manager 174 sends to or receives data transmissions from one or more communication services databases 176 via network 180. Communication services manager 174 sends to or receives data transmissions from one or more communication services advisors 178 via network 180. Communication services database 176 sends to or receives data transmissions from communication services advisor 178 via network 180. Communication services advisor 178 receives from or sends to switch 172 voice or data transmissions.

Communication services manager 174 facilitates one or more services such as, but not limited to, enrollment services, navigation assistance, directory assistance, roadside assistance, business or residential assistance, information services assistance, emergency assistance, communications assistance, and telematics retrieval of vehicle system performance information. In an embodiment, communication services manager 174 receives service requests for a vehicle emission performance data update from a user via user computer 150, web-hosting portal 160, and land network 144. Communication services manager 174 transmits and receives operational status, instructions and other types of vehicle data to telematics device 120 in mobile vehicle 110 through wireless carrier system 140, communication network 142, land network 144, wireless modem 124, voice and data switch 172, and network 180. Communication services manager 174 stores or retrieves vehicle system performance information from communication services database 176. Communication services manager 174 provides requested information to communication services advisor 178.

In one embodiment, communication services advisor 178 is a real advisor. In another embodiment, communication services advisor 178 is implemented as a virtual advisor. In an example, a real advisor is a human being at a service provider service center in verbal communication with a service subscriber in mobile vehicle 110 via telematics device 120. In another example, a virtual advisor is implemented as a synthesized voice interface responding to requests from telematics device 120 in mobile vehicle 110. In another embodiment, communication services advisor 178 is embodied in software executing on a computing system that provides automated configurable dynamic telematic retrieval of vehicle system performance information.

Communication services advisor 178 provides services to telematics device 120 in mobile vehicle 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics device 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

Mobile vehicle 110 initiates service requests to call center 170 by sending a voice or digital-signal command to telematics device 120 which, in turn, sends an instructional signal or a voice call through wireless modem 124, wireless carrier system 140, communication network 142, and land network 144 to call center 170. In another embodiment, the service request is for a vehicle system performance information upload that initiates a vehicle system performance information transfer between vehicle 110 and service center 170 or web-hosting portal 160. In another embodiment, mobile vehicle 110 receives a request from call center 170 to send various types of vehicle system performance information from mobile vehicle 110 through telematics device 120 through wireless modem 124, wireless carrier system 140, communication network 142, and land network 144 to call center 170. In one embodiment, one or more triggers stored in the telematics device 120 cause the vehicle to initiate a service request. The trigger is, for example, a number of ignition cycles, a specific time and date, an expired time, a number of kilometers, an absolute Global Positioning System (GPS) timestamp, a request vehicle emission performance data, and the like.

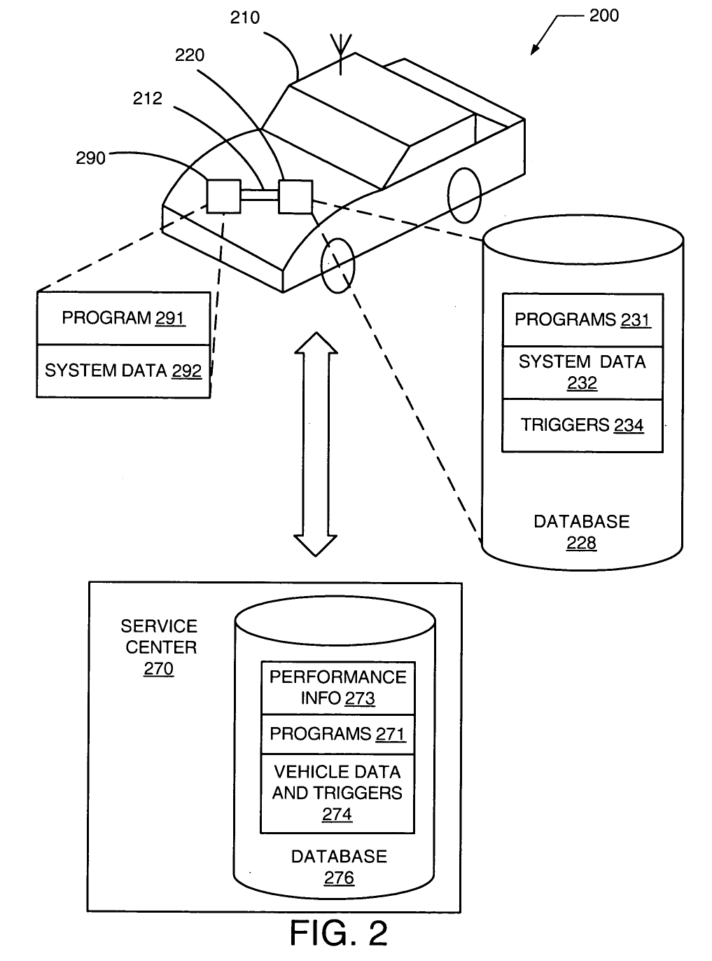

FIG. 2 is a block diagram of a system for configurable dynamic telematic retrieval of vehicle system performance information in accordance with an embodiment of the present invention. FIG. 2 shows a telematics-based vehicle system performance information retrieval system 200 (retrieval system). In one embodiment, the components of retrieval system 200 are operational within an illustrative operating environment according to FIG. 1.

In FIG. 2, retrieval system 200 includes a telematics service center 270, and a mobile vehicle 210 having a telematics device 220 that is coupled to one or more vehicle system modules 290 via a communication network 212. The telematics device 220 is shown including a database 228 that contains programs 231, vehicle system performance data 232, and event triggers 234. The vehicle system module 290 is shown including a program 291 and vehicle system performance data 292. The service center 270 is shown including a database 276 containing vehicle system performance information 273, programs 271, and event triggers 274. The telematics service center is shown in communication with the telematics device 220 in vehicle 210. In one embodiment, communication network 212 coupling telematics device 220 to vehicle system modules 290 is a direct connection between the connected devices. In another embodiment, communication network 212 is a vehicle communication network 112 as described in FIG. 1. In one embodiment, vehicle system performance data 232 comprises vehicle system performance information.

Mobile vehicle 210 is any type of vehicle including a passenger vehicle, bus, truck, and the like that includes integrated vehicle system modules 290 such as engine emission sensors and a telematics device. In one embodiment, vehicle 210 and various systems of vehicle 210 are uniquely identifiable via an assigned identification code such as, for example, a vehicle identification number (VIN) or a device identification code of a vehicle system module 290 or telematics device 220.

Telematics device 220 is any telematics device enabled for operation with a telematics service provider such as telematics device 120 as described with reference to FIG. 1. In one embodiment, telematics device 220 is coupled to communication network 212 for communicating data between vehicle system modules 290 and the telematics device 220. Telematics device 220 includes volatile and non-volatile memory components for storing data and programs. In one embodiment, memory components in telematics device 220 contain database 228. In an embodiment, database 228 includes one or more programs 231 for performing and managing vehicle system performance analysis processes and data transfers such as, for example, an emission data analysis module, and other programs 231 for detecting vehicle system performance update triggers, emission analysis data requests, and the like. In one embodiment, an emission analysis program module performs various analytic processes on vehicle performance data received from a vehicle performance measurement system to render vehicle performance data.

In an embodiment, analytic processes performed by telematics device 220 include analyzing combustion efficiency and by-products, sulphurous compound content, and the like. In another embodiment, an emission data upload module manages performance information 232 such as analyzed emission data, engine emission data, triggers 234, and dynamic configuration data commands and programs 231. In still another embodiment, the telematics device 220 acts as a data cache for performance information 232 such as, for example, emission data, caching any data received from a vehicle system module 290 such as an engine emission sensor.

Vehicle system module 290 (VSM) is any vehicle system control module having software or hardware or both components for operating, controlling, or monitoring one or more vehicle system parameters. In one embodiment, vehicle system module 290 is a vehicle system controller such as, for example, a power train control module (PCM). Other embodiments feature controllers that affect other vehicle systems, including the chassis, body, and information and entertainment systems. In another embodiment, VSM 290 contains one or more processors, one or more memory devices, one or more sensors such as for example, emissions sensors, and one or more connection ports for communicating vehicle system data to and from the VSM 290. In an embodiment, VSM 290 is coupled to a vehicle communication network 212 and, therefore, to any other device that is also coupled to vehicle communication network 212. In another embodiment, VSM 290 is connected directly to telematics device 220.

In an embodiment, VSM 290 includes one or more programs 291 and vehicle system performance data 292 stored in memory. In one embodiment, program 291 includes computer code instructions for managing emission data monitoring processes. In another embodiment, program 291 includes computer code instructions for managing chassis data monitoring processes. In another embodiment, program 291 includes computer code instructions for managing body data monitoring processes. In another embodiment, program 291 includes computer code instructions for managing information and entertainment system data monitoring processes. In still another embodiment, VSM 290 is configured as an engine emission sensor that senses parameters and provides a digital or analog output data signal proportional to a measured parameter. In still another embodiment, VSM 290 is a vehicle emission sensor such as, for example, an oxygen sensor, a carbon monoxide sensor, a carbon dioxide sensor, a temperature sensor, a pressure or pressure gradient sensor, and the like. In an embodiment, VSM 290 is a passive engine emission sensor that outputs an emission measurement system data signal. In another embodiment, VSM 290 is an active engine emission sensor that outputs an emission data signal. In other embodiments, VSM 290 controls or monitors a vehicle system such as a powertrain, a chassis, a body, or an information or entertainment subsystem. For each VSM 290, one or more system performance parameters are measured to generate vehicle system performance data 292, including, but not limited to, system operational parameters, real-time measurements, operator settings, and the like.

Telematics service center 270 is any service center providing telematics services such as call center 170 described with reference to FIG. 1. In one embodiment, service center 270 includes hardware and software for managing a database 276 having vehicle system performance information 273. In another embodiment, service center 270 is configured to access a database that is in another location but coupled to service center 270 such as, for example, database 166 in web server 160 as described in FIG. 1. In an embodiment, database 276 contains records of vehicle system performance information 273. Vehicle system performance information 273 includes raw data such as vehicle system performance data retrieved from vehicle 210 and processed data such as analyzed vehicle system performance data retrieved from vehicle 210. In another embodiment, database 276 includes one or more programs for managing emission analysis data. In yet another embodiment, database 276 is a relational database that includes vehicle data and triggers 274 such as, for example, vehicle makes and models, individual vehicle identification numbers (VIN) and other vehicle identifiers, and vehicle performance analysis configuration data corresponding to specific vehicles of the database. In an embodiment, triggers 271 and performance analysis configuration data or instructions are communicated from service center 270 to telematics unit 220 during a telematics enabled communication session between service center 270 and telematics unit 220. Configuration data includes instructions and data to reconfigure the telematics unit for vehicle system performance analysis operations such as specific data processing sequences when performance data are received from a vehicle system module 290. Other forms of configuration data include time intervals to report emission analysis data, or absolute GPS timestamps, and the like.

In operation, service center 270 manages the retrieval and compilation of vehicle system performance information through a telematics service provider network such as the operating environment described in FIG. 1. In an embodiment, service center 270 is enabled to concatenate, and otherwise manage, vehicle system performance information for a plurality of vehicles 210. In operation, service center 270 receives vehicle system performance information from vehicle 210 and stores the vehicle system performance information in database 276. A trigger such as, for example, the expiration of a periodic time interval or an absolute GPS timestamp initiates a communication from vehicle 210 to service center 270. In an embodiment, a request for vehicle system performance information is provided from the service center 270 to the telematics device 220 of mobile vehicle 210.

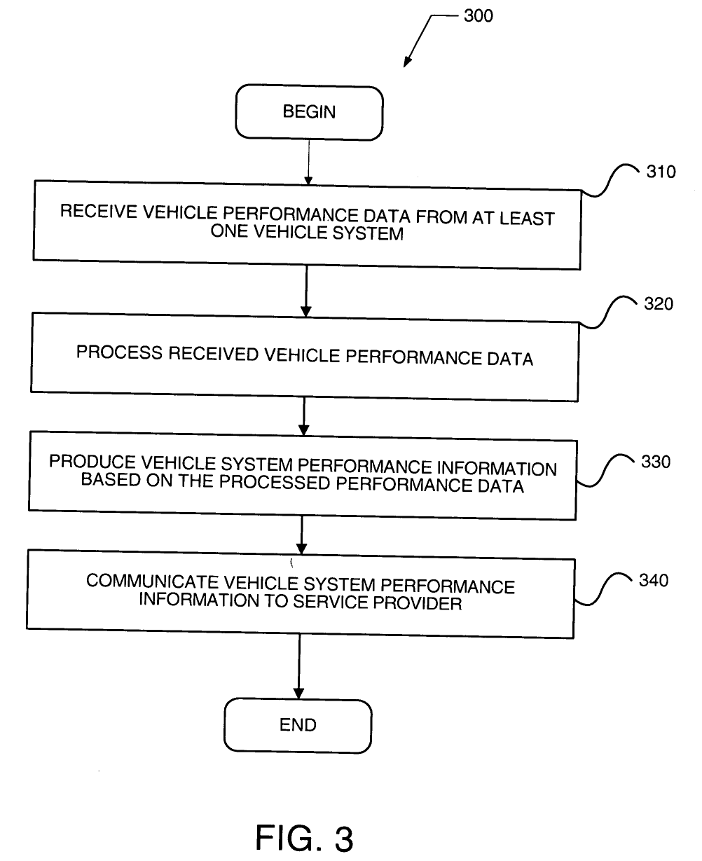

FIG. 3 is a process flow diagram of a method for telematic retrieval of vehicle emission performance information. In one embodiment, method 300 is implemented with components of the exemplary systems described with reference to FIGS. 1 and 2. In another embodiment, one or more steps of method 300 are embodied in a computer readable medium containing computer readable code. Method 300 begins in step 310. In step 310, vehicle performance data is received from at least one vehicle system. In one embodiment, the vehicle performance data is received at a telematics device at any time that a mobile vehicle 210 is operational. In an embodiment, the received vehicle performance data is the output of a vehicle system module 290. In another embodiment, the received vehicle performance data is the output of an engine emission sensor. In one embodiment, the received vehicle performance data is received in an onboard DSP 122.

In step 320, the vehicle performance data is processed. The vehicle performance data is processed at any time after the vehicle performance data is received. In one embodiment, the vehicle performance data is processed by DSP 122.

In an embodiment, processing the received vehicle performance data includes evaluating the received vehicle system performance data and storing the evaluated vehicle system performance data. In another embodiment, evaluating the received vehicle performance data includes comparing the received vehicle system performance data from each vehicle system to an expected vehicle system performance data range, flagging the vehicle system performance data as valid when the vehicle system performance data is within an expected vehicle system performance range, and flagging the data as invalid when the vehicle system performance data is not within an expected vehicle system performance range. In one embodiment, an emission sensor provides vehicle performance data. An emission sensor generally has expected ranges of output values. Data output from an emission sensor that exceeds the nominal expected sensor operating ranges indicates a sensor error, system malfunction, or an engine condition requiring attention. In another embodiment, processing the vehicle performance data includes caching the vehicle performance data. In still another embodiment, processing the vehicle performance data includes storing the vehicle performance data to volatile or non-volatile memory or a database.

In step 330, vehicle system performance information is produced based on the processed vehicle performance data. The vehicle system performance information is produced at any time after the vehicle performance data is processed. In one embodiment, producing the performance information includes retrieving the evaluated vehicle system performance data, analyzing the evaluated vehicle system performance data and storing the analyzed vehicle system performance data as vehicle system performance information. In one embodiment, the vehicle system performance information is produced by DSP 122.

In step 340, the vehicle system performance information is communicated to a service provider. The vehicle system performance information is communicated at any time after the vehicle system performance information is produced. In an embodiment, communicating the vehicle system performance information includes detecting a vehicle system performance information upload trigger and initiating at least one communication session with the service provider responsive to detecting the vehicle system performance information upload trigger. In one embodiment, the vehicle system performance information is sent from DSP 122 to telematics unit 120 and then communicated to the call center 170.

An embodiment includes receiving at least one vehicle system performance information request from the service provider and sending vehicle system performance information to the service provider responsive to the request. Another embodiment includes receiving updated vehicle system performance information upload triggers from the service provider and storing the updated vehicle system performance information upload triggers at the telematics device. In such an embodiment, a service center requests vehicle system performance information from call center 170, call center 170 requests the vehicle system performance information from the telematics unit 120, telematics unit 120 requests the vehicle system performance information from DSP 122, and the information is then passed back up the chain of requestors.

Yet another embodiment includes transmitting vehicle system performance information to the service provider responsive to initiating the at least one communication session. Thus, after the call center 170 receives the vehicle system performance information, the call center 170 transmits the vehicle system performance information to a service provider. In an embodiment, performance information is engine emission data, emission analysis data, evaluated engine emission data, event triggers, and dynamic configuration data.

Still another embodiment includes receiving a vehicle system performance analysis configuration from a service provider, storing the vehicle system performance analysis configuration at the telematics unit, where the vehicle performance information is produced at the telematics unit based on the stored vehicle system performance analysis configuration.

In the above manner, vehicle performance data from one or more vehicle systems is received at a telematics device for processing and production of vehicle performance information. Valid vehicle performance data is stored at a telematics unit and then analyzed. The analyzed performance data is periodically delivered through a communication session from the telematics unit to a service provider based on triggering events, with the analyzed data then stored to a database at the service provider. During a communication session, the service provider requests specific vehicle performance information and provides telematics device configuration instructions and triggers.

It is anticipated that the invention will be embodied in other specific forms not described that do not depart from its spirit or essential characteristics. The described embodiments are to be considered in all respects only as illustrative and not restrictive.

1. A method for configurable dynamic telematic retrieval of vehicle system performance information, comprising:
receiving vehicle performance data at a telematics device from at least one vehicle system;
processing the received vehicle performance data at the telematics device;
producing vehicle system performance information based on the processed vehicle performance data; and
communicating the vehicle system performance information to a service provider.

2. The method of claim 1 wherein processing the received vehicle system performance data comprises:
evaluating the received vehicle system performance data; and
storing the evaluated vehicle system performance data.

3. The method of claim 2 wherein evaluating the received vehicle system performance data comprises:
comparing the received vehicle system performance data from each vehicle system to an expected vehicle system performance data range;
flagging the vehicle system performance data as valid when the vehicle system performance data is within an expected vehicle system performance range; and
flagging the data as invalid when the vehicle system performance data is not within an expected vehicle system performance range.

4. The method of claim 2 wherein producing the vehicle system performance information comprises:
retrieving the evaluated vehicle system performance data;
analyzing the evaluated vehicle system performance data; and
storing the analyzed vehicle system performance data as vehicle system performance information.

5. The method of claim 1 further comprising:
receiving a vehicle system performance analysis configuration from a service provider;
storing the vehicle system performance analysis configuration at the telematics device;
wherein vehicle performance information is produced at the telematics unit based on the stored vehicle system performance analysis configuration.

6. The method of claim 1 wherein communicating the vehicle system performance information comprises:
detecting a vehicle system performance information upload trigger; and
initiating at least one communication session with the service provider responsive to detecting the vehicle system performance information upload trigger.

7. The method of claim 6 further comprising:
receiving at least one vehicle system performance information request from the service provider; and
sending vehicle system performance information to the service provider responsive to the request.

8. The method of claim 7 further comprising:
receiving updated vehicle system performance information upload triggers from the service provider; and
storing the updated vehicle system performance information upload triggers at the telematics device.

9. The method of claim 6 further comprising:
transmitting vehicle system performance information to the service provider responsive to initiating the at least one communication session.

10. The method of claim 6 wherein the vehicle system performance data is selected from the group consisting of:
vehicle engine emission data, vehicle powertrain data, vehicle chassis data, vehicle body data, and vehicle information and entertainment system data.

11. A computer readable medium storing a computer program comprising:
computer readable code for directing a reception of vehicle performance data at a telematics device from at least one vehicle system;
computer readable code for processing the received vehicle performance data at the telematics device;
computer readable code for producing vehicle system performance information based on the processed vehicle performance data; and
computer readable code for directing a communication of the vehicle system performance information to a service provider.

12. The computer readable medium of claim 11 wherein computer readable code for processing the received engine data comprises:
computer readable code for evaluating the received vehicle system performance data; and
computer readable code for storing the evaluated vehicle system performance data.

13. The computer readable medium of claim 12 wherein computer readable code for evaluating the received emission data comprises:
computer readable code for comparing the received vehicle system performance data from each vehicle system to an expected vehicle system performance data range;
computer readable code for flagging the vehicle system performance data as valid when the vehicle system performance data is within an expected vehicle system performance range; and
computer readable code for flagging the data as invalid when the vehicle system performance data is not within an expected vehicle system performance range.

14. The computer readable medium of claim 12 wherein computer readable code for producing the emission analysis data comprises:
computer readable code for retrieving the evaluated vehicle system performance data;
computer readable code for analyzing the evaluated vehicle system performance data; and
computer readable code for storing the analyzed vehicle system performance data as vehicle system performance information.

15. The computer readable medium of claim 11 further comprising:
computer readable code for directing a reception of a vehicle system performance analysis configuration from a service provider;
computer readable code for storing the vehicle system performance analysis configuration at the telematics device;
wherein vehicle performance information is produced at the telematics unit based on the stored vehicle system performance analysis configuration.

16. The computer readable medium of claim 15 wherein computer readable code for directing the communication of performance information comprises:
computer readable code for detecting a vehicle system performance information upload trigger; and
computer readable code for initiating at least one communication session with the service provider responsive to detecting the vehicle system performance information upload trigger.

17. The computer readable medium of claim 16 further comprising:
computer readable code for directing a reception of at least one vehicle system performance information request from the service provider; and
computer readable code for sending vehicle system performance information to the service provider responsive to the request.

18. The computer readable medium of claim 17 further comprising:
computer readable code for storing updated engine emission performance data upload triggers received from the service provider.

19. The computer readable medium of claim 16 further comprising:
computer readable code for directing a transmission of vehicle system performance information to the service provider responsive to initiating the at least one communication session.

20. A system for configurable dynamic telematic retrieval of vehicle system performance information comprising:
means for receiving vehicle performance data at a telematics device from at least one vehicle system;
means for processing the received vehicle performance data at the telematics device;
means for producing vehicle system performance information based on the processed vehicle performance data; and
means for communicating the vehicle system performance information to a service provider.
